(19) United States
(12) Patent Application Publication
(10) Pub. No.: US 2002/0026408 A1
(43) Pub. Date: Feb. 28, 2002

(54) Method and apparatus for enrolling with multiple request for quote providers

(76) Inventors: Anne O'Malley, New York, NY (US); Stefan Teodosic, New York, NY (US); Dennis Tze, Ridgewood, NJ (US); Eve Reiter, New York, NY (US); Pragnesh Ray, Pembrcke Pines, FL (US)

Correspondence Address: SNELL & WILMER, ONE ARIZONA CENTER, 400 EAST VAN BUREN, PHOENIX, AZ, 850040001

(21) Appl. No.: 09/934,818

(22) Filed: Aug. 22, 2001

Related U.S. Application Data
(60) Provisional application No. 60/227,496, filed on Aug. 24, 2000.

(51) Int. Cl. G06F 17/60

(52) U.S. Cl. 705/37; 705/26

(57) ABSTRACT

The present invention facilitates the enrollment of a user with multiple request for quote (RFQ) providers. An RFQ provider facilitates the quote/bid process between a user (e.g., a merchant or seller) and a supplier (e.g., a merchant or seller). A quote may include a bid on a product or service that the user has an interest in. A user may submit data related to user information, an RFQ, and/or the like to a request for quote enrollment (RFQE) system. Upon submitting the data to the RFQE system, the user is registered in the RFQE system. The RFQE system uses an integrated system of information to enroll the user with multiple RFQ providers. Thus, the RFQE system expands the distribution opportunities for the user and saves the user time by enrolling the user with multiple RFQ providers.

### RELATED APPLICATIONS

This patent application claims priority to, and the benefit of, the U.S. provisional patent application entitled “REQUEST FOR QUOTE ENROLLMENT” filed on Aug. 24, 2000 as U.S. Ser. No. 60/227,496, the entire contents of which is hereby incorporated by reference.

### FIELD OF INVENTION

The present invention generally relates to the enrollment of a user in a request for quote provider system, and more particularly, to a system and method for the enrollment of a user in multiple request for quote systems.

### BACKGROUND OF THE INVENTION

Request for quote (RFQ) providers provide one or more quotes to users in connection with various areas of business and commerce, wherein the users may transact or otherwise communicate in a business to business environment, a business to customer environment, and/or a customer to customer environment depending on the context of the transaction. A user is typically a customer (e.g., desiring to purchase and/or sell a product, service or other item of commerce). A user may also be a merchant, a distributor, a supplier, a seller, and/or the like. An RFQ is a user's request for a bid (e.g., price bid) and/or other information, wherein the user may want to purchase, sell, lease, rent, use or exploit in any way a product or service (see generally, e.g., American Express® RFQ Services at www.americanexpress.com). An RFQ provider is typically a person, entity, or organization, which requests quotes for a product or service from one or more suppliers. A supplier may be a merchant, a distributor, a manufacturer, a seller, and/or the like. A user enrolled with an RFQ provider typically receives a quote from a supplier via the RFQ provider in connection with a product or service. The user responds to the quote by accepting, rejecting, or ignoring the quote.

However, a current problem with the RFQ process is that a user often enrolls with different RFQ providers, such that the user typically completes different enrollment applications, which is a time consuming and inefficient process. Thus, a method and apparatus for facilitating the enrollment of a user with multiple RFQ providers is desired.

### SUMMARY OF THE INVENTION

The present invention facilitates the enrollment of a user with multiple request for quote (RFQ) providers. To register, a user may submit data related to user information, the type of RFQ that the user desires to receive, and/or the like to a request for quote enrollment (RFQE) system. The RFQE system uses an integrated system of information to enroll the user with multiple RFQ providers. For example, the RFQE system communicates with the RFQ providers via a communication channel in order to transfer user data, receive information from the RFQ providers, and otherwise facilitate communication between the user and the RFQ providers. In this manner, the present invention relieves the user from having to enroll with each RFQ provider individually (e.g., visit many RFQ provider web sites and enroll multiple times). Thus, the RFQE system expands the distribution opportunities for the user and saves the user time by enrolling the user with multiple RFQ providers.

### BRIEF DESCRIPTION OF THE DRAWINGS

The subject invention will hereinafter be described in the context of the appended drawing figures, wherein like numerals denote like elements, and:

FIG. 1 illustrates a system for enrolling a user with multiple RFQ providers in accordance with an exemplary embodiment of the present invention;

FIG. 2 illustrates a system for enrolling a user with multiple suppliers in accordance with an exemplary embodiment of the present invention;

FIG. 3 is a flowchart illustrating a method for facilitating enrollment of a user with multiple RFQ providers in accordance with an exemplary embodiment of the present invention; and

FIG. 4 illustrates a system for enrolling a browser with multiple RFQ providers using an RFQE system having a web server, an application server, an outbound proxy server, and a database server in accordance with an exemplary embodiment of the present invention.

### DETAILED DESCRIPTION OF EXEMPLARY EMBODIMENTS

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as Basic, C, C++, Java, COBOL, assembler, PERL, eXtensible Markup Language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to validate data with a user-side scripting language, such as JavaScript, VBScript or the like.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

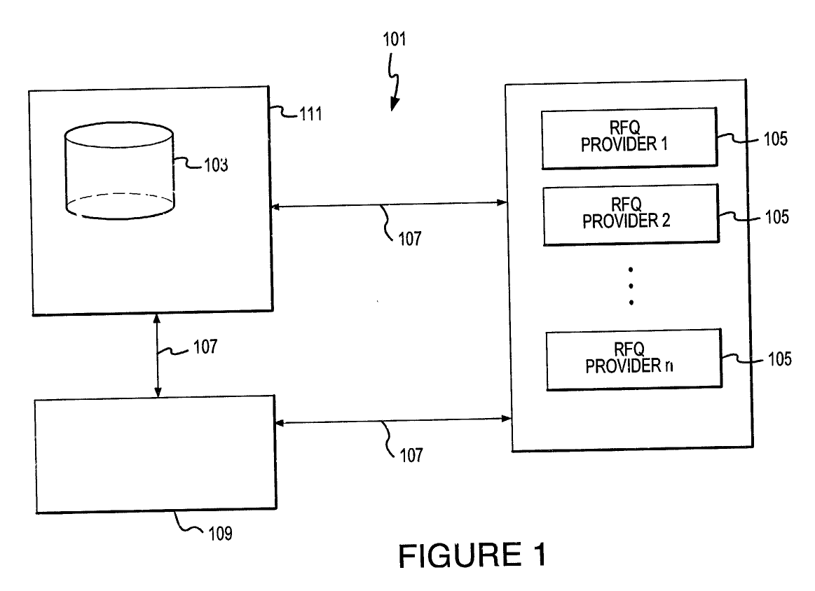

A system 101 in accordance with an exemplary embodiment of the present invention is illustrated in FIG. 1. In an exemplary embodiment, system 101 includes a request for quote enrollment (RFQE) system 111, a communication channel 107, and a number (n) of request for quote (RFQ) providers 105. System 101 allows a user 109 to make a request for quote (RFQ) from RFQ providers 105 via RFQE system 111. By registering in RFQE system 111, RFQE system 111 may facilitate the enrollment of a user 109 in multiple RFQ providers 105.

User 109 is typically a customer desiring to purchase and/or sell a product, service or other item of commerce from a supplier (not shown). User 109 uses RFQ providers 105 as a liaison to various suppliers in order to purchase and/or sell a product or service. User 109 may alternatively be a merchant, a distributor, a supplier, a person, an entity, software, hardware and/or the like desiring to transact or otherwise communicate with a customer, a supplier, a distributor, and/or a manufacturer. In this manner, user 109 may transact or otherwise communicate in a business to business environment, a business to customer environment, and/or a customer to customer environment depending on the context of the transaction. User 109 may interact with the various elements of system 101 via any input device such as a keyboard, mouse, kiosk, personal digital assistant, handheld computer (e.g., Palm Pilot®), cellular phone and/or the like.

RFQE system 111 includes a database 103 and is suitably configured to facilitate the enrollment of a user 109 in multiple RFQ providers 105. User 109 may register in RFQE system 111 by submitting data in connection with user 109 to RFQE system 111. In addition, each of RFQ providers 105 may register in RFQE system 111 by submitting data to RFQE system 111. The registration into RFQE system 111 may involve submitting data related to, for example, a user name, a user password, a reconfirmation password, a password recovery question, user contact information (e.g., name, title, company name, address, phone, facsimile, e-mail, and/or the like), industry or market information, company information, product or services categories, user personal information (e.g., citizenship, racial background, etc.), and/or the like. In addition, RFQE system 111 assists users with, for example, data security, non-preferential branding among competitors, catalog and inventory maintenance and/or the like.

User 109 and RFQ providers 105 may use any suitable communication means (e.g., communication channel 107) to submit the data to RFQE system 111. Communication channel 107 may be any type of communication means which provides any form of communication between the various elements (e.g., between RFQE system 111 and RFQ providers 105). It will be appreciated, that many applications of the present invention could be formulated. One skilled in the art will appreciate that communication channel 107 may include any system for exchanging data or transacting business, such as any hardware and/or software communication medium (e.g., telephone, modem, digital subscriber line, a global computer network, a wired link, a wireless link, any utility link), the Internet, an intranet, an extranet, WAN, LAN, satellite communications, and/or the like. It is noted that communication channel 107 may be implemented as any type of network, such as open network, secured network, an interactive television (ITV) network. Furthermore, communication channel 107 may be one network or multiple independent networks. The invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like.

The data submitted from user 109 and/or RFQ providers 105 to RFQE system 111 may optionally be stored in database 103 (e.g., back-up data, tracking information, and/or the like). A database, e.g., database 103, may be any type of database, such as relational, hierarchical, object-oriented, and/or the like. Common database products that may be used to implement each database include DB2 by IBM (White Plains, N.Y.), any of the database products available from Oracle Corporation (Redwood Shores, Calif.), Microsoft SQL Server by Microsoft Corporation (Redmond, Wash.), or any other database product. Each database may be organized in any suitable manner, including as data tables or lookup tables. Thus, upon submitting the data to RFQE system 111, user 109 and/or RFQ providers 105 are registered in RFQE system 111.

Once RFQE system 111 obtains the data from user 109, user 109 may be enrolled with any number (n) of RFQ providers 105. For example, user 109 may complete one integrated enrollment form on a web site (e.g., completing a user enrollment form at www.americanexpress.com). RFQ providers 105 include any RFQ providers, e.g., Onvia.comSM, BuyerZone.comSM, SmallBusinessDepotSM, and/or the like. In addition, the number n of RFQ providers 105 may be any number depending on the needs and context of system 101. In an alternate exemplary embodiment of the present invention, RFQE system 111 may itself include any number of RFQ providers, such that RFQ providers 105 are included within RFQE system 111.

Once user 109 is registered in RFQE system 111, then data in connection with user 109 may be communicated to multiple RFQ providers 105 (e.g., by using the integrated enrollment form information, as discussed below). RFQE system 111 communicates the data to RFQ providers 105 via communication channel 107. RFQE system 111 communicates the data to RFQ providers 105 by transmitting, transferring, or otherwise communicating the data to RFQ providers 105 via communication channel 107. For example, RFQE system 111 may configure the data for simultaneous transfer to multiple RFQ providers 105. The computing units used by user 109, RFQE system 111, and RFQ providers 105 may be connected with each other via communication channel 107 (e.g., a data communication network). The network may be a public network and assumed to be insecure and open to eavesdroppers. In the illustrated implementation, the network may be embodied as the internet. In this context, the computers may or may not be connected to the internet at all times. For instance, a user computer may employ a modem to occasionally connect to the internet, whereas an RFQE system or universal service system computing center might maintain a permanent connection to the internet. Various systems and servers are suitably coupled to the network via data links. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. The various systems might also reside within a local area network (LAN) which interfaces to the network via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

RFQE system 111 may communicate the data to RFQ providers 105 using at least one protocol in at least one format. For example, RFQE system 111 may configure the data in a format and communicate the data to RFQ providers 105 using a protocol (e.g., sending enrollment information to RFQ providers 105 via a business-to-business communication channel (e.g., using https and XML)). In one exemplary embodiment of the present invention, RFQE system 111 and RFQ providers 105 may have a predetermined protocol and format in order to facilitate the communication of the data from RFQE system 111 to RFQ providers 105. Thus, once the data is communicated to RFQ providers 105, then RFQ providers 105 process the data in order to enroll user 109 into each of their respective systems. As such, user 109 becomes enrolled with RFQ providers 105.

Exemplary protocols include hyper text transfer protocol (http), secured hyper text transfer protocol (https), file transfer protocol, secure electronic mail, a network, remote method invocation, distributed component object model, enterprise java bean, and/or socket communication. One embodiment of the present invention may be implemented with TCP/IP communications protocols, IPX, Appletalk, IP-6, NetBIOS, OSI or any number of existing or future protocols. For a basic introduction of cryptography, please review a text written by Bruce Schneider which is entitled “Applied Cryptography: Protocols, Algorithms, And Source Code In C,” published by John Wiley & Sons (second edition, 1996), which is hereby incorporated by reference. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

Exemplary formats include extensible markup language (XML), name value pair, any custom format, any industry standard format, and/or the like. For example, XML is a markup language for documents including structured information. Structured information includes content (e.g., words, pictures, and/or the like) and some indication of the type of content (e.g., heading, footnote, figure, database table, etc.). In this manner, a markup language can identify structures in a document (e.g., by adding markup to the document). Documents include, for example, traditional documents, vector graphics, electronic commerce transactions, mathematical equations, object meta-data, server Application Programming Interfaces, and/or the like. The XML language (e.g., XML schemas) may describe and constrain the content of XML documents.

Upon successful enrollment with RFQ providers 105, user 109 receives notification of the enrollment. The notification may be communicated to user 109 from RFQE system 111 and/or RFQ providers 105. For example, user 109 may be notified of the enrollment and requested to submit further information to RFQE system 11 1 and/or RFQ providers 105. In addition, user 109 may submit further data directly to RFQ providers 105. For example, user 109 may submit profiling information and/or the like directly to RFQ providers 105.

Once the data is communicated from RFQE system 111 to RFQ providers 105, then RFQ providers 105 may use the data to provide one or more quotes to user 109 and/or to solicit one or more quotes from a supplier (not shown). In this manner, RFQ providers 105 may behave as an RFQ provider, a supplier, a merchant, a distributor, a manufacturer, and/or the like. A quote may include a bid on a product or service, information on a product or service, and/or the like. A quote may be in relation to any product or service that user 109 may have an interest in or is offering for sale, and may further be based on information on user 109 (e.g., profiling information on user 109). The supplier may be a seller, a merchant, an RFQ provider, a manufacturer, and/or any other entity related to providing, obtaining, and/or securing the quote. If the quote is obtained from the supplier, then the quote is communicated to at least one of RFQ providers 105. Once any of RFQ providers 105 receive a quote from the supplier or can otherwise provide a quote, RFQ providers 105 may communicate the quote to user 109. RFQ providers 105 may communicate the quote to user 109 via any means including a hard copy, a soft copy, an electronic copy (e.g., electronic mail, any protocol, any format, etc.), a communication channel, and/or the like. Alternatively, the quote may be directly communicated from the supplier to user 109.

Upon receiving the quote from any of RFQ providers 105 or otherwise, user 109 may accept, reject, or ignore the quote. User 109 may communicate the decision to accept, reject, or ignore the quote to RFQ providers 105 and/or RFQE system 111 via any communication means. For example, user 109 may send an electronic mail message to RFQ providers 105 and/or RFQE system 111 signifying acceptance or rejection of the quote. In one exemplary embodiment of the present invention, user 109 receives one or more quotes from a web site of any of RFQ providers 105. As such, user 109 may access the web site of any of RFQ providers 105 to receive and respond to one or more quotes.

If user 109 ignores the quote or rejects the quote, then user 109 is not affected by the quote (e.g., user 109 is not legally or financially obligated in connection with the quote). If, however, user 109 accepts the quote from any of RFQ providers 105 and/or the supplier, then user 109 may be obligated (e.g., legally, financially, or otherwise). For example, user 109 may be obligated to provide further information to RFQ providers 105, provide a product or service, and/or pay a fee (e.g., pay a commission to RFQ providers 105). As such, the RFQ provider, from which user 109 accepted the quote, may bill user 109, if user 109 accepts that quote from that RFQ provider. In addition, RFQ providers 105 may also be obligated (e.g., legally, financially, or otherwise) to pay RFQE system 111 and/or the supplier a fee (e.g., flat fee, commission, and/or the like). Thus, user 109 may be obligated to RFQ providers 105 and/or RFQE system 111 (or RFQ providers 105 may also be obligated RFQE system 111) due to previously determined relationships (e.g., prior executed/signed agreements).

In an exemplary embodiment of the present invention, all obligations (e.g., legal, financial, or otherwise) between user 109, RFQ providers 105, RFQE system 111, and/or third parties are coordinated by RFQ providers 105. For example, RFQ providers 105 would service any requests by user 109 and/or the supplier related to payment of financial obligations, legal obligations, customer complaints, and/or the like. Optionally, RFQ providers 105 may report such obligations to RFQE system 111 for tracking information. Such information related to the obligations of user 109 may form the basis for determining any fees owed to RFQE system 111 by user 109 and/or RFQ providers 105. Such information may include enrollment information, quote acceptance/rejection information, revenue information, attrition information, customer issues, and/or the like. Alternatively, obligations (e.g., legal, financial, or otherwise) between user 109, RFQ providers 105, RFQE system 111, and/or third parties may be coordinated directly between each party.

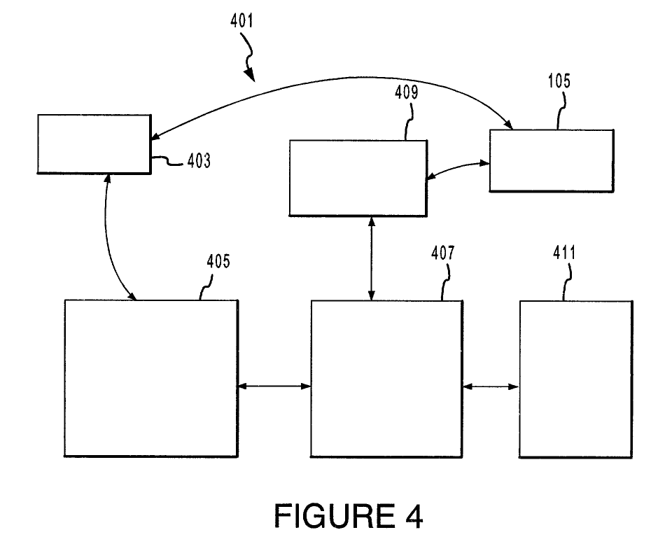

System 401 in FIG. 4 illustrates an alternate embodiment of the present invention. System 401 includes a browser 403 (e.g., user 109) which posts an application form, so that browser 403 may submit data to a web server 405. In this manner, browser 403 may register with RFQE system 111. An exemplary embodiment of RFQE system 111 includes web server 405, an application server 407, an outbound proxy server 409, and a database server 411. Browser 403 passes input field values, e.g., using https, to web server 405. As such, browser 403 submits data to web server 405 and web server 405 sends the data to application server 407. Data from the application server 407 may be stored in and retrieved from a database server 411. Application server 407 transmits the data to RFQ providers 105 via outbound proxy server 409. For example, application server 407 transmits the data to outbound proxy server 409 in XML format. Outbound proxy server 409 may transfer the data to and receive data from RFQ providers 105 using https and an XML format. Accordingly, by transferring data to and receiving data from RFQ providers 105, browser 403 may be enrolled with multiple RFQ providers 105. Thus, browser 403 may receive one or more quotes from RFQ providers 105 either directly, or indirectly via outbound proxy server 409, application server 407, and web server 405.

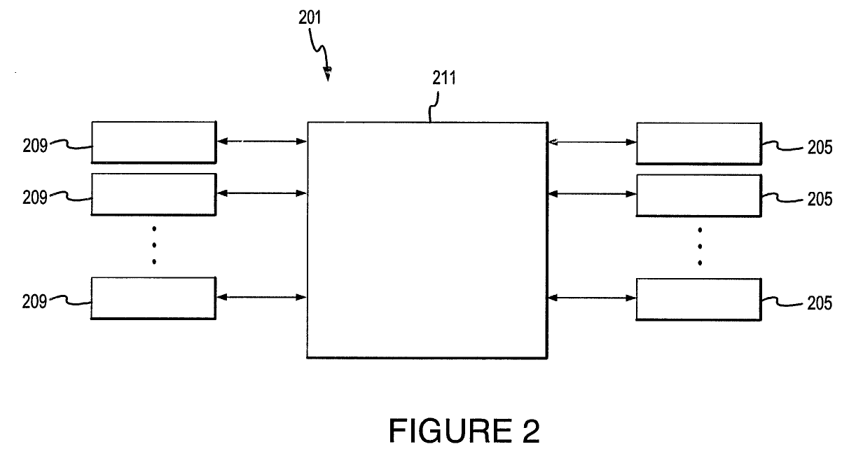

Referring to FIG. 2, system 201 illustrates another alternate embodiment of the present invention. System 201 includes a universal service system 211, a number of users 209, and a number of suppliers 205. Universal service system 211 facilitates communication and/or interaction between one or more users 209 and multiple suppliers 205. Users 209 and suppliers 205 may be in the context of a business to business transaction, a business to customer transaction, a customer to customer transaction, and/or the like. Similar to RFQE system 111 of FIG. 1, universal service system 211 facilitates communication between users 209 and suppliers 205. System 201 may be implemented in any context in which a user desires facilitated access to or communication with multiple suppliers. For example, system 201 may include an electronic auction system, which facilitates communication between users 209 (e.g., auction buyers) and suppliers 205 (e.g., auction sellers), such as the system on www.ebay.com, which is hereby incorporated by reference. Moreover, system 201 contemplates the use, sale or distribution of any goods, services, items of commerce or information over any network having similar functionality described herein.

In order to further describe the present invention, the following provides further exemplary embodiments for the various elements of the present invention. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same.

However, data tables having similar, though not identical, data in the key fields may also be merged by using AGREP, for example. Also, the association of XML data is done using Document Type Definition (DTD) and schemas.

Communication between the various entities and the system of the present invention is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

Each entity may use a computing system to facilitate online commerce transactions. The user may use a computing unit in the form of a personal computer, although other types of computing units may be used including laptops, notebooks, hand held computers, set-top boxes, and the like. RFQE system 111, universal service system 211, RFQ providers 105, and/or suppliers 205 may use a computing unit implemented in the form of a computer server, a computing center (e.g., a main frame computer), a mini-computer, a PC server, a network set of computers, and/or the like.

Optionally, a user computing unit, an RFQ provider computing system, an RFQE system, a universal service system, and/or a supplier computing unit may be interconnected via a second network, such as a payment network. The payment network represents existing proprietary networks that presently accommodate transactions for credit cards, debit cards, and other types of financial/banking cards. The payment network is a closed network that is assumed to be secure from eavesdroppers. Examples of the payment network include the American Express®, VisaNet® and the Veriphone® network.

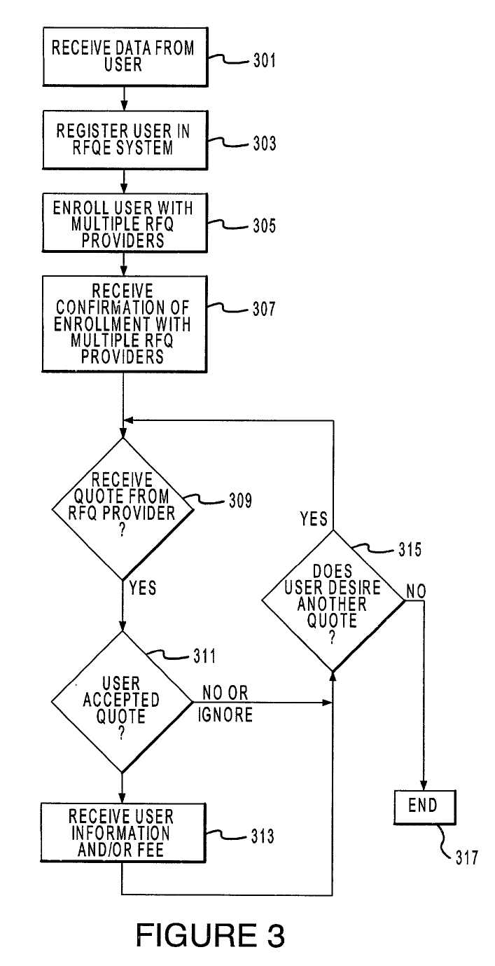

An exemplary method of the present invention is illustrated in the flowchart of FIG. 3. This exemplary embodiment of the present invention may be implemented in any context as well, and is described in the context of an RFQ system for illustrative purposes only. System 101 may receive data in connection with at least one user (e.g., user 109) (step 301). In one exemplary method of the present invention, RFQE system 111 receives data in connection with user 109. Once the data is received, user 109 may be registered in RFQE system 111 (step 303). Once user 109 is registered in RFQE system I 111, then RFQE system 111 may enroll user 109 with multiple RFQ providers 105 (step 305). Upon being enrolled with RFQ providers 105, confirmation of the enrollment is communicated to RFQE system 111 and/or user 109 (step 307). After registration with RFQ providers 105, user 109 may receive one or more quotes (e.g., from RFQ providers 105) (step 309). If user 109 does not receive a quote, then the process reiterates until either user 109 receives a quote or a predetermined amount of time has lapsed (e.g., some number of iterations of checking for receipt of a quote). Once user 109 receives a quote from an RFQ provider, then user 109 may accept, reject, or ignore the quote. If user 109 accepts the quote in step 311, then user 109 may be obligated to provide further information, provide a product or service, and/or pay a fee (step 313). If, however, user 109 rejects or ignores the quote, then user 109 has no obligation to submit further information or pay a fee in connection with that quote. Upon rejecting or ignoring the quote (step 311) or accepting the quote (step 313), a check is made to determine if user 109 desires to receive another quote from any of RFQ providers 105 (step 315). If user 109 desires to receive another quote from any of RFQ providers 105, then step 309 is repeated. If, however, user 109 does not wish to receive another quote from any of RFQ providers 105, then this exemplary iteration of an RFQ process ends (step 317). This exemplary method may continue for any number of users in connection with any number of quotes from any number of RFQ providers 105.

Thus, the present invention provides methods and apparatus for facilitating the enrollment of a user with multiple RFQ providers. By registering the user in an RFQE system, the RFQE system may enroll the user with multiple RFQ providers thereby facilitating communication between the user and the various RFQ providers. Instead of the user to communicating directly with each RFQ provider and enroll individually with each RFQ provider, the present invention allows the user to register in one integrated RFQE system. The RFQE system may then enroll the user with multiple RFQ providers thereby facilitating the enrollment process for the user. Thus, the user may use one integrated RFQE system and register just one time, but receive the benefit of enrolling with multiple RFQ providers.

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

What is claimed is:

1. A method for enrolling a user in multiple request for quote providers, comprising the steps of:
obtaining data on the user, wherein the user submits the data to a request for quote enrollment system having a memory and a processor;
storing the data in the memory and using the processor to configure the data for transfer to the multiple request for quote providers;
transferring the data from the request for quote enrollment system to the multiple request for quote providers via a communication channel; and
enrolling the user in multiple request for quote providers.

2. The method of claim 1, further comprising the step of soliciting profiling information from the user.

3. The method of claim 2, further comprising the step of receiving at least one quote in connection with the user from at least one of the multiple request for quote providers, wherein the at least one quote is based on the profiling information from the user.

4. The method of claim 1, further comprising the step of receiving at least one quote in connection with the user from at least one of the multiple request for quote providers.

5. The method of claim 4, further comprising the step of billing the user if the user accepts the at least one quote in connection with the user.

6. The method of claim 1, further comprising the step of compiling at least one of enrollment, quote, quote acceptance, and billing data in connection with the user.

7. A method for facilitating the enrollment of a user with multiple request for quote providers, comprising the steps of:
registering a user with a request for quote enrollment system by submitting data in connection with the user to the request for quote enrollment system;
sending confirmation information to the user in connection with the registration of the user with the request for quote enrollment system; and
configuring the request for quote enrollment system such that the user is capable of being enrolled with multiple request for quote providers.

8. The method of claim 7, wherein the data includes user profiling data.

9. The method of claim 7, further comprising the step of sending the user at least one quote from at least one of the multiple request for quote providers.

10. The method of claim 7, further comprising the step of reporting information in connection with at least one of the registration of the user, the enrollment of the user, and any quotes accepted by the user.

11. A method for requesting at least one quote for a user in a request for quote system, comprising the steps of:
receiving user data into a request for quote enrollment system;
transferring the user data from the request for quote enrollment system to a plurality of request for quote providers, wherein the user becomes enrolled with the plurality of request for quote providers;
receiving at least one quote, from at least one of the plurality of the request for quote providers, at the request for quote enrollment system; and
distributing the at least one quote to the user.

12. A method for facilitating the enrollment of a user in multiple request for quote provider systems, comprising the steps of:
receiving data in connection with the user;
enrolling the user with the multiple request for quote providers via a communication channel;
receiving confirmation of the enrollment of the user with the multiple request for quote providers;
requesting additional data from the user via at least one request for quote provider; and
receiving at least one quote from at least one request for quote provider.

13. A method for facilitating the enrollment of a user in multiple request for quote provider systems, comprising the steps of:
requesting data in connection with the user via a web server;
receiving data in connection with the user by posting an application form via the web server;
transmitting the data from the web server to an application server;
enrolling the user with multiple request for quote providers by transmitting the data from the application server to the multiple request for quote providers via an outbound proxy server; and
receiving information in connection with the user if the user accepts a quote from at least one of the multiple request for quote providers.

14. The method of claim 13, further comprising the step of receiving a sales commission in connection with the user if the user accepts a quote from at least one of the multiple request for quote providers.

15. The method of claim 13, further comprising the step of collecting data in connection with the enrollment of the user.

16. The method of claim 13, further comprising the step of collecting data in connection with any quotes accepted by the user.

17. A computer implemented method for facilitating the enrollment of a user in multiple request for quote provider systems, comprising the steps of:
obtaining data on the user, wherein the user submits the data to a request for quote enrollment system having a memory and a processor;
storing the data in the memory and using the processor to configure the data for transfer to the multiple request for quote providers;
transferring the data from the request for quote enrollment system to the multiple request for quote providers via a communication channel; and
enrolling the user in the multiple request for quote providers.

18. A method for enrolling a user in multiple request for quote providers, comprising the steps of:
receiving a request for data from a request for quote enrollment system;
submitting data to the request for quote enrollment system via a communication channel coupled to the request for quote enrollment system, wherein the user becomes registered in the request for quote enrollment system;
receiving confirmation information of the registration from the request for quote enrollment system, wherein the request for quote enrollment system further enrolls the user in a plurality of request for quote providers;
receiving confirmation information of the enrollment with the plurality of request for quote providers; and
receiving at least one quote from at least one of the plurality of request for quote providers, wherein the user accepts, rejects, or ignores the quote.

19. A method for enrolling a user in multiple request for quote providers, comprising the steps of:
submitting data in connection with a plurality of request for quote providers to a request for quote enrollment system, wherein the plurality of request for quote providers become registered into the request for quote enrollment system;
obtaining data on the user from the request for quote enrollment system;
enrolling the user with the plurality of request for quote providers, where the plurality of request for quote providers process the data on the user; and
sending confirmation of enrollment information to the user upon enrolling the user with the plurality of request for quote providers.

20. A request for quote system, comprising:
a request for quote enrollment system having a host server for processing data in connection with a user and a database for collecting data on the user; and
a communication channel coupled between the request for quote enrollment system and a plurality of request for quote providers for transmitting at least a portion of the data from the request for quote enrollment system to the plurality of request for quote providers, wherein the user becomes enrolled in the plurality of request for quote providers.

21. The request for quote system of claim 20, wherein the communication channel includes a protocol and a format.

22. The request for quote system of claim 21, wherein the protocol includes at least one of hyper text transfer protocol, secured hyper text transfer protocol, file transfer protocol, secure electronic mail, a network, remote method invocation, distributed component object model, enterprise java bean, and socket communication, and the format includes at least one of extensible markup language and name value pair.

23. The request for quote system of claim 20, wherein the user provides additional data to at least one of the plurality of request for quote providers.

24. The request for quote system of claim 20, wherein the user receives at least one quote from at least one of the plurality of request for quote providers.

25. The request for quote system of claim 20, wherein at least one of the plurality of request for quote providers bills the user if the user accepts the at least one quote from at least one of the plurality of request for quote providers.

26. The request for quote system of claim 25, wherein at least one of the plurality of request for quote providers pays a sales commission to the request for quote enrollment system if the user accepts the at least one quote from at least one of the plurality of request for quote providers.

27. A data communication system, comprising:
a database for receiving data on at least one user;
a processor coupled to the database for configuring the data in a format for transfer to a plurality of request for quote providers;
a communication means in communication with the database and the processor for transmitting the data to the plurality of request for quote providers; and
at least one computing unit related to the plurality of request for quote providers for receiving the data and enrolling the user with the plurality of request for quote providers.

28. A request for quote enrollment system, comprising:
a host server including a processor for processing data in connection with a user;
a memory coupled to the processor for storing the data;
an input digitizer coupled to the memory and the processor for inputting the data into the memory; and
an application program stored in the memory and accessible by the processor for directing processing of the data by the processor, wherein the application program is configured to:
obtain data on the user, wherein the user submits the data to the host server;
store the data in the memory and use the processor to configure the data for transfer to the multiple request for quote providers;
transfer the data from the host server to the multiple request for quote providers via a communication channel; and
enroll the user in the multiple request for quote providers.

29. A communication system, comprising:
a user computing unit, coupled to a request for quote enrollment system via a communication channel, for submitting data in connection with the user to the request for quote enrollment system; and
a plurality of request for quote providers, in communication with the request for quote enrollment system, for receiving the data from the request for quote enrollment system and enrolling the user in the plurality of request for quote providers, wherein at least one of the plurality of request for quote providers submits a quote to the user.
